(19) United States
(12) Patent Application Publication
(10) Pub. No.: US 2011/0094352 A1
(43) Pub. Date: Apr. 28, 2011

(54) Double ended ratcheting box end wrench having different measurement systems

(76) Inventor: Fred Reinstein, Beverly Hills, CA (US)

(21) Appl. No.: 11/436,543

(22) Filed: May 19, 2006

Related U.S. Application Data
(60) Provisional application No. 60/682,869, filed on May 20, 2005.

(51) Int. Cl. B25B 13/06; B25B 23/00

(52) U.S. Cl. 81/124.4; 81/125.1

(57) ABSTRACT

One end of a wrench is a first measurement system, such as SAE, and the second end is another measurement system, such as metric, that is close in size to the first end. It is possible to know approximately the correct size wrench needed but not the measurement system. Having two measurement systems in a single tool allows a user to pick a single wrench and have a high probability that one end of the wrench will correctly fit the nut or bolt. The end may be any type of socket, such as open ended or box ended, and the box end may be supplied with a ratchet mechanism. The combination of a first measurement system and a second measurement system on each end, close in size to one another, the ratcheting box end and the ability to reverse the ratchet action direction greatly reduces time and effort in the removal and tightening of bolts and nuts.

This application claims benefit of provisional application 60/682,869, filed May 20, 2005.

### BACKGROUND OF THE INVENTION

It is not uncommon to have an item, such as an engine, having both metric and SAE nuts and bolts. It is also not relatively apparent which measurement system the nut or bolt uses, metric or SAE, by simple visual inspection. Some metric sizes are very close to some SAE sizes, making the selection of the correct wrench more difficult. To pick the correct wrench, it is often necessary to try both SAE and metric wrenches to find the correct fit. The user must first approximate the size of the nut or bolt and then try wrenches of both systems. This can be a frustrating and time consuming process, especially when working in tight confines.

It is an object of the invention to provide a wrench with both metric and SAE sockets.

It is another object of the invention to facilitate the choice of the correct wrench for a task.

It is yet another object of the invention to provide a wrench with two ratcheting box ends, each being a different measurement system.

These and other objects of the invention will become apparent to one of ordinary skill in the art after reading the disclosure of the invention.

### SUMMARY OF THE INVENTION

One box end is a first measurement system, such as SAE, and the the second box end is another measurement system, such as metric, that is close in size to the first box end. It is possible to know approximately the correct size wrench needed but not the measurement system. Having both box ends in a single tool allows a user to pick a single wrench and have a high probability that one end of the wrench will correctly fit the nut or bolt.

The combination of a first measurement system and a second measurement system on each end, close in size to one another, the ratcheting box end and the ability to reverse the ratchet action direction greatly reduces time and effort in the removal and tightening of bolts and nuts.

### BRIEF DESCRIPTION OF THE DRAWING

FIG. 1 is a perspective view of the wrench.

### DETAILED DESCRIPTION OF THE INVENTION

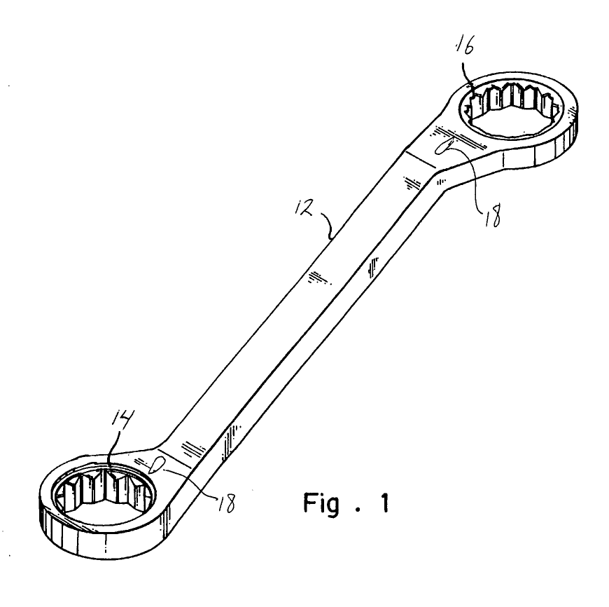

FIG. 1 shows the wrench having a shaft 12 and box ends 14, 16. Each of the box ends has a ratchet interior surface 18, allowing a bolt or nut to be tightened or loosened without removing the wrench from the bolt or nut. At both ends of the shaft is a switch 18, such as a toggle switch, allowing for the ratchet direction to be changed, allowing for both tightening or loosening.

One end 14 fits an SAE nut whereas the second end 16 fits a metric size nut. The metric end is the closest in size to the SAE end. Sockets for SAE wrenches are generally sized every 1/8 th of an inch. Similarly, metric sockets are sized every millimeter. The metric end is the size that is closest in size to the SAE end, either slightly smaller or slightly bigger. For instance, the SAE size 5/8 th of an inch is very close to 15 millimeters. However, this is simply a single example for illustrative purposes and the principal can be applied to any size. The metric size may be slightly larger or slightly smaller.

The wrench allows the user to approximate the size of the nut to be removed and choose a wrench which has a high likelihood of being the correct size, regardless of whether the nut is SAE or metric.

While the invention has been described with reference to a preferred embodiment, variations and modifications would be apparent to one of ordinary skill in the art without departing from the scope of the invention. The invention encompasses such variations and modifications. For instance, the box ends do not have to be ratcheting and the ends may be another type of socket, such as open ended, rather than a box end.

I claim:

1. A wrench comprising
a shaft having a first end and a second end,
a first box end at the first end, said first box end having a first socket in a first measurement system,
a second box end at the second end, said second box end having a second socket in a second measurement system, said second measurement system being different from the first.

2. The wrench of claim 1, wherein the second socket is the closest in size to the first socket.

3. The wrench of claim 1, wherein the first measurement system is SAE and the second measurement system is metric.

4. A wrench comprising
a shaft having a first end and a second end,
a first socket at the first end, said first socket in a first measurement system,
a second socket at the second end, said socket in a second measurement system, said second measurement system being different from the first.

5. The wrench of claim 4, wherein the second socket is the closest in size to the first socket.

6. The wrench of claim 4, wherein the first measurement system is SAE and the second measurement system is metric.

7. The wrench of claim 4, wherein the first and second sockets are box ends.
